(19) United States
(12) Patent Application Publication
(10) Pub. No.: US 2005/0098657 A1
(43) Pub. Date: May 12, 2005

(54) Dispensing head for a dosing device

(76) Inventor: Christa Wohriska, Steisslingen, DE (US)

Correspondence Address: FLYNN THIEL BOUTELL & TANIS, P.C., 2026 RAMBLING ROAD, KALAMAZOO, MI, 49008-1699, US

(21) Appl. No.: 10/815,547

(22) Filed: Apr. 1, 2004

(30) Foreign Application Priority Data
Apr. 2, 2003 (DE) 103 15 934.7

(51) Int. Cl. B67D 5/22

(52) U.S. Cl. 239/461

(57) ABSTRACT

1. A dispensing head for a dosing device. 2.1 A dispensing head for a dosing device comprising an outer component part which has at least one outlet nozzle, and comprising an inner component part which has a flow-channel arrangement for supplying a medium to be dispensed to the outlet nozzle, whereby a flow-guiding system, in particular a swirler device, viewed in dispensing direction, is placed in the path toward the outlet nozzle, is known. 2.2 The flow-guiding system is according to the invention integrated in the outer component part. 2.3 Use for cosmetic sprayers.

### FIELD OF THE INVENTION

The invention relates to a dispensing head for a dosing device comprising an outer component part which has at least one outlet nozzle, and comprising an inner component part which has a flow-channel arrangement for supplying a medium to be dispensed to the outlet nozzle, whereby a flow-guiding system, in particular a swirler device, viewed in dispensing direction, is placed in the path toward the outlet nozzle.

### BACKGROUND OF THE INVENTION

A dispensing head for a dosing device for dispensing a medium is known from the DE 198 13 178 A1 (corresponding to U.S. Pat. No. 6,257,461). The dispensing head is manufactured of plastic and has a flow-channel arrangement in a center area, which flow-channel arrangement can be connected to a flow path or a pump system, where the dispensing head is mounted onto a suitable component part of the pump system. The flow-channel arrangement extends coaxially to a center longitudinal axis of the cap-shaped dispensing head inside of the dispensing head to a front-side cap area of the dispensing head. There the flow-channel arrangement transfers into a flow-channel section which terminates in an outlet opening. In front of the outlet opening there is arranged a sliding part provided with an outlet nozzle, which sliding part can be positioned into an operating position in front of a swirler system of the flow-channel section, which swirler system serves as a flow-guiding system. The sliding part is also manufactured out of plastic and is preferably manufactured in one piece and together with the dispensing head. In a resting position, which is defined after the manufacture of the component parts, the sliding part is held through the finest injection-molded connections on the input side of a sliding groove extending transversely with respect to the flow-channel section. The fine connections are separated by pressing the sliding component downwardly so that the sliding part can be moved downwardly in the sliding groove, which causes the outlet nozzle integrated into the sliding part to be positioned in front of the swirler system. The swirler system is formed in one piece in the area of the flow-channel section inside of the cap-shaped dispensing head.

It is also known (DE 198 45 910 A1, corresponding to U.S. Pat. No. 6,427,876) not to movably position a sliding part provided with an outlet nozzle in a dispensing head for a dosing pump in the area of a sliding groove but rather to move this part in corresponding sliding guides on the outer surfaces of the dispensing head. Thus the outlet nozzle is arranged directly on the outer surface of the dispensing head. Also this dispensing head has a swirler device positioned in the area of a flow-channel arrangement.

The operation of the dispensing head and thus the operation of the dosing device depends in the case of both dispensing heads from the exact positioning of the respective sliding part in front of the swirler device and thus, viewed in flow direction, on the output side of the flow-channel arrangement. Due to the fact that the swirler device is formed in one piece on the dispensing head each in the area of the flow-channel arrangement, a plastic component part, which is relatively complicated in design, is needed.

The purpose of the invention is to provide a dispensing head of the above-identified type, which is simple to manufacture yet has a high operating safety.

### SUMMARY OF THE INVENTION

This purpose is attained by integrating the flow-guiding system into the outer component part. Thus it is possible to design the inner component part, which is regularly connected to the dosing device, extremely simple. The integration of the flow-guiding system into the outer component part enables a direct association of the flow-guiding system with the outlet nozzle. A swirler device is advantageously provided, which is adjusted to the design of the outlet nozzle in such a manner that the desired dispensing form for the medium is achieved. The medium is preferably a liquid and the flow-guiding system and the outlet nozzle are designed such that a swirling of the liquid and a breaking off of the smallest liquid droplets occurs on the output side of the outlet nozzle in such a manner that a spray mist results. The inventive solution is preferably usable for dosing devices in the cosmetic field. A preferred embodiment utilizes the dispensing head for miniaturized sprayers in the cosmetic field. These miniaturized sprayers can be with the inventive solution have particularly small designed dispensing heads. The outside diameter of such dispensing heads is preferably less than 10 mm. The integration of the flow-guiding system into the outer component part enables an extremely easy mounting of the outer component part on the inner component part, since an alignment between the inner and outer component part is no longer needed for the operationally secure association of the flow-guiding system and the outlet nozzle. A cap-like or sleeve-like component part is provided in particular as the outer component part, which cap-like or sleeve-like component part grips around the inner component part. It is also possible to provide as the outer component part a part, which similarly to the sliding parts from the mentioned state or the art extends merely over a partial peripheral area of the inner component part. In such a component part it can also be held in guideways of the inner component part.

The outer component part is designed in a further development of the invention as a plastic part, and the flow-guiding system is constructed in one piece on the component part. The outer component part is manufactured preferably as an injection-molded part out of a polyolerin, in particular out of polypropylene or polyethylene.

The outer component part is in a further development of the invention designed annularly and the at least one outlet nozzle is integrated in one piece in the annular component part. By the one-piece integration of the outlet nozzle into the outer component part, no additional operations are needed for the manufacture of the outlet nozzle. The outlet nozzle is designed via an injection-molding method together with the manufacture of the outer component part. The annular design of the outer component part enables a mounting of the outer component part onto correspondingly rotation-symmetrical sections of the inner component part so that a rotating ability between the inner and outer component part exists. Both the outer and also the inner component part represent preferably extremely simply designed injection molded parts.

The inner component part is in a further development of the invention designed as a plastic part, and is adjusted as a fill body in such a manner to the annular outer component part that the two component parts can be joined forming an annular space keeping open a flow path to the flow-guiding system and the outlet nozzle, which annular space is part of the flow-channel arrangement. The annular space is flow-technically connected to the flow-guiding system and the at least one outlet nozzle. Since the annular space is in addition part of the flow-channel arrangement, a flow path between the dosing device and the outlet nozzle is always made available independent from the respective rotary position of the outer component part by guaranteeing from the annular space a connection to the outlet nozzle and to the dosing device.

An annular space is not provided in a further, inventive embodiment. Yet the outer component part can be mounted on the inner component part and can be rotated relative to same. In order to enable a dispensing operation, the outer component part is rotated in a simple manner until the outlet nozzle including the flow-guiding system is in front of a corresponding flow-channel section of the flow channel arrangement. Now a suitable dosing operation is possible. By again rotating the outer component part, the temporary connection between the outlet nozzle and the flow-channel arrangement is again interrupted, which makes a further dispensing operation no longer possible.

The outer component part and the inner component part are in a further development of the invention arranged rotatably coaxially to one another, and in particular also coaxially to the annular space. At least the peripheral surfaces of the outer component part, which peripheral surfaces face one another, and the inner component part are designed rotationally symmetrically in order to achieve a corresponding rotary support for the outer component part.

Axially acting locking means, referred to a center longitudinal axis of the inner component part are, in a further development of the invention, provided for the axial fixing of the outer component part no the inner component part. An operationally secure positioning is in this manner achieved even during the operation of the dosing device.

The outlet nozzle is in a further development of the invention aligned radially to the center longitudinal axis of the inner component part, in particular radially to the annular space. This design is particularly advantageous for use in spray heads for cosmetic sprayers.

The peripheral surfaces of the dispensing cap and of the pump cap, which peripheral surfaces face one another, have in a further development of the invention adjacent to the annular space diameters, which are adjusted to one another, so that a circumferentially sealed fit in the joined state is achieved. This guarantees that no medium, in particular no liquid, escapes at undesired areas from the dispensing head.

A protective or covering top provided with an outlet opening can in a further development of the invention be releasably mounted onto the outer component part, the outlet opening of which top is designed larger than the outlet nozzle. The protective or covering top can serve as a lock for the dispensing head. The top is alternatively or supplementarily merely a cover for the dispensing head, which cover can be created in accordance with the respectively desired design requirements. An operationally secure mounting is advantageously achieved by a simple insertion-withdrawal operation.

### BRIEF DESCRIPTION OF THE DRAWINGS

Further advantages and characteristics of the invention result from the claims and from the following description of one preferred exemplary embodiment of the invention illustrated in the drawings, in which:

FIG. 1 is a half cross-sectional illustration of one embodiment of an inventive dispensing head for a dosing device;

FIG. 2 is a front view of the dispensing head according to FIG. 1 in the area of an outlet nozzle;

FIG. 3 is a cross-sectional view of an outer component part of the dispensing head according to FIG. 1;

FIG. 4 illustrates a portion of the component part according to FIG. 3 taken along the cross-sectional line IV-IV of FIG. 3;

FIG. 5 is an enlarged cross-sectional illustration of a portion V of the component part according to FIG. 3;

FIG. 6 is a cross-sectional illustration of an inner component part of the dispensing head according to FIG. 1, which component part is to be connected to the dosing device;

FIG. 7 is a front view of the component part according to FIG. 6; and

FIG. 8 is a top view of the component part according to FIGS. 6 and 7.

### DETAILED DESCRIPTION

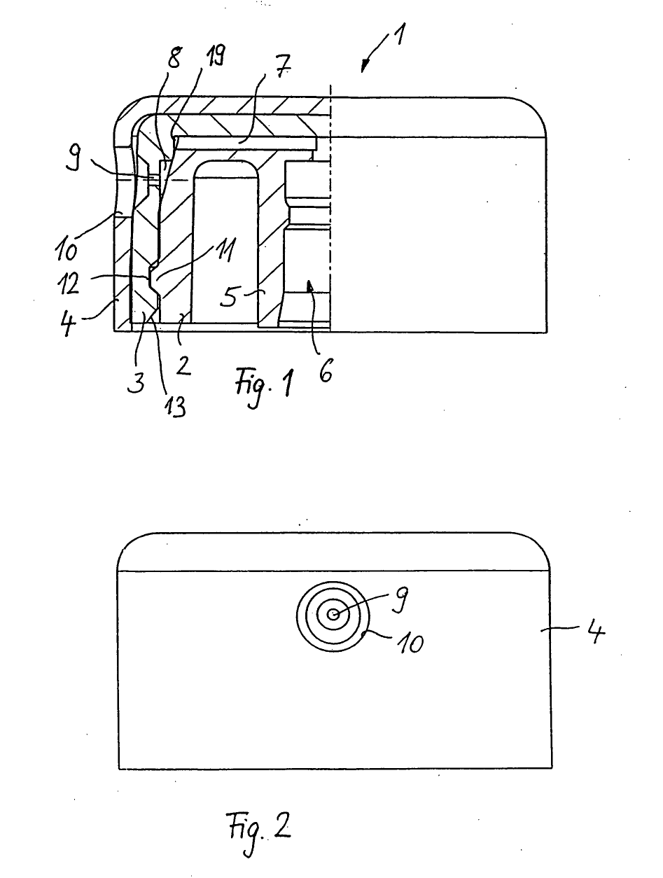

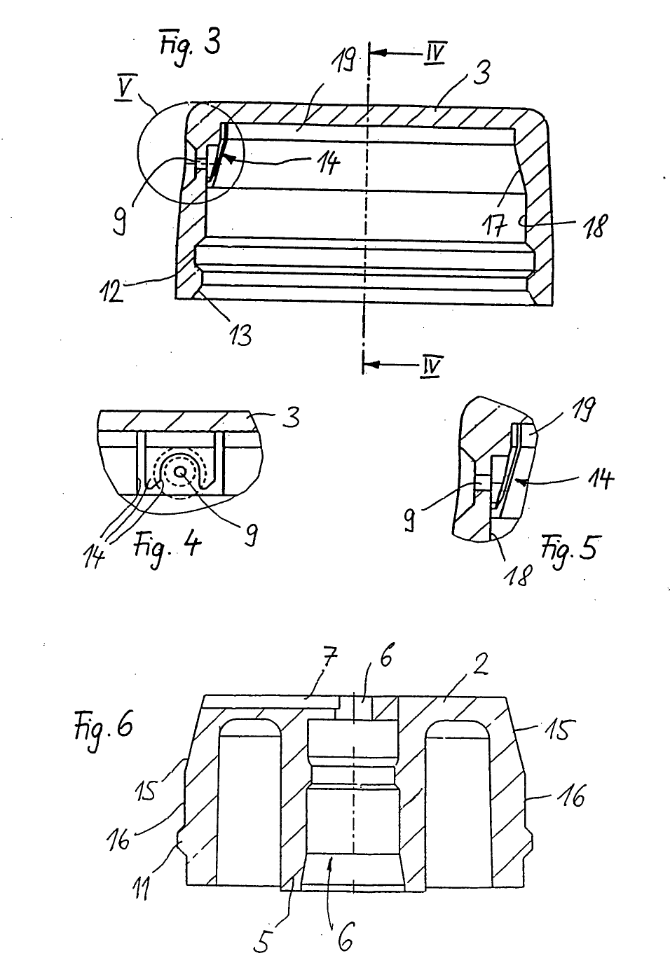

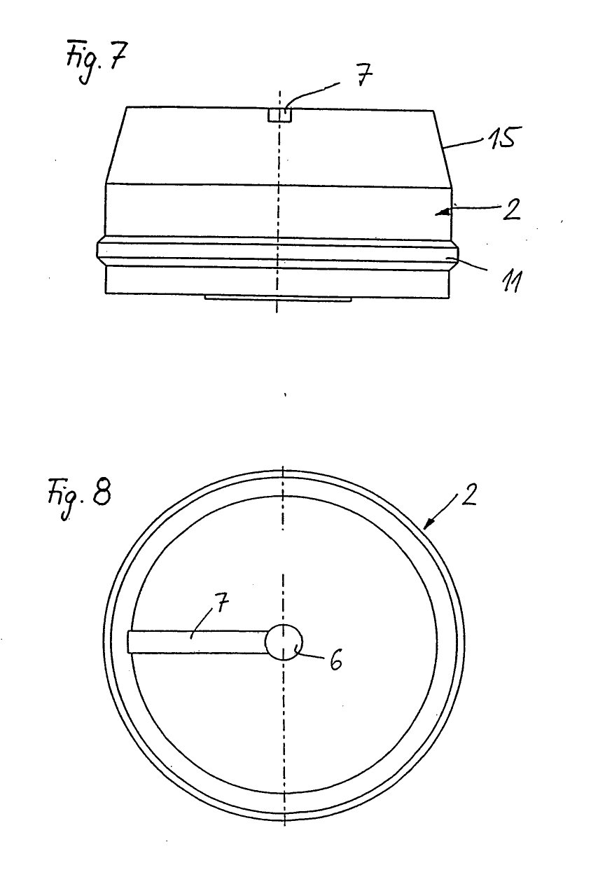

A dispensing head according to FIGS. 1 to 8 represents a spray head for a dosing device in the form of a spray pump not illustrated in detail. Both the spray head 1 and also the not illustrated spray pump are designed miniaturized, whereby the spray head 1 has preferably a diameter of between approximately 8 mm and 12 mm. The spray head 1 can be mounted in a basically conventional and therefore not in detail illustrated manner onto a pump system of the spray pump. The spray head 1 consists of two component parts, each designed as one-piece plastic injection molded parts. An inner component part 2, which can be connected to the pump system, serves as the fill body for an outer component part 3. The inner component part 2 is designed cap-like or sleeve-like and is also identified as pump cap. The outer component part 3 is also designed cap-like and can also be identified as a dispensing cap.

A protective or covering top 4 is in addition mounted on the outer component part 3, which top 4 has an outlet opening 10. The protective or covering top 4 is of no importance for the operation of the spray head 1. The protective or covering top 4 can therefore also be eliminated if no special demands are placed on the design or the look of the dosing device.

Both component parts 2, 3 are preferably made out of polyethylene or polypropylene. The inner component part 2 and also the outer component part 3 are designed essentially rotation-symmetrical with respect to a center longitudinal axis of the spray pump, referred to the mounted state of the spray head 1. In order to be able to mount the spray head 1 onto the pump system of the spray pump, the inner component part 2 has a mount connector 5 aligned coaxially with respect to the center longitudinal axis of the spray pump inside of the component part 2, and which is designed open toward the not illustrated pump system, and which has on its inside an inner profiling 6 so that a corresponding connector of the pump system can be inserted into the mount connector 5 and can engage same. The space created by the inner profiling 6 inside of the mount connector 5, is, while forming a flow-channel arrangement 6, 7, open through a top cap area of the component part 2. An axial channel section 6, which is aligned coaxially with respect to the center longitudinal axis, is formed in this manner. The upwardly facing side of the top cap area of the component part 2 has an upwardly open radial groove which forms a radial flow-channel section 7 of the flow-channel arrangement. The flow-channel section 7 extends radially outwardly starting from the axial channel section so that a radial flow path results for a respective medium.

The outer component part 3 is also designed cap-shaped, whereby it is designed essentially rotation-symmetrical with respect to the center longitudinal axis. The component part 3 has in the area of its upper side an upwardly facing cap area designed as a flat surface. From same projects downwardly an integral annular wall and coaxially with respect to the center longitudinal axis. An outlet nozzle 9 is integrally integrated into the annular wall below the top cap area, which outlet nozzle 9 has an outlet axis that is radial relative to the center longitudinal axis. The component part 3 has a cylindrical space section on the inside in a base area directly following the top cap area, which space section forms an annular space 19 in cooperation with the inner component part 2. This will be discussed in greater detail later on. A downwardly conically enlarging annular-wall section 17 follows the cylindrical space section, at the height of which annular-wall section 17 is provided the radial outlet nozzle 9 in the annular wall. The outlet nozzle 9 has a cylindrical opening of approximately 0.2 mm to 0.3 mm. This cylindrical opening is followed outwardly by an enlarged outlet area, which conically enlarges to the outside. The diameter of this enlarged outlet area lies between approximately 0.6 mm and 1 mm.

A swirler device 14 is placed on the inside in the path toward the outlet nozzle 9, which swirler device 14 is illustrated enlarged and detailed in FIGS. 4 and 5. The swirler device 14 is constructed in one piece with the component part 3 on the inside of the annular-wall section 17. The swirler device 14 has a swirler plate, which is arranged on the inside spaced from the outlet nozzle 9 and projects downwardly starting from the base are at the height of the annular-space section 19. The swirler plate has according to FIG. 4 forklike or bar-like webs arranged on both sides of the outlet nozzle 9 spaced from the inside wall of the annular-wall section 17 in the area of the outlet nozzle 9. The annular-wall section 17 is designed not conically, but rather cylinder-section-shaped at the height of the outlet nozzle 9 by a cylindrical annular-wall section 18, which starts below the conical annular-wall section 17, being guided aligned upwardly in the area of the outlet nozzle 9. The swirler plate of the swirler device 14 projects elastically flexibly downwardly in such a manner that in spite of the partly inclined alignment parallel to the conical extent of the annular-wall section 17 a simple unmolding in axial direction is possible during the injection molding. The swirler plate is, viewed in peripheral direction of the component part 3, cut free on both sides, which results in flow slots extending from the top downwardly. These have the purpose, in a manner, which will be described in greater detail hereinafter, to move liquid from the annular space section 19 downwardly in front of the outlet nozzle 9. The desired spray mist can be achieved during an exiting of the liquid through the outlet nozzle 9 by the simultaneous spraying of the liquid caused by the turbulences achieved through the swirler plate.

The inner component part 2 has at its upper end a flat cover surface, which is only interrupted by the radial groove of the flow-channel section 7 and the opening for the axial channel section 6. Starting out from the cover section, the component part 2 has an outer sleeve 15, 16, which at a distance coaxially surrounds the mount connector 5. The outer sleeve has an annular-sleeve section 15 which, starting from the cover area, conically enlarges downwardly, and which is followed by a cylindrical annular-sleeve section 16. The dimensions of the conical annular-sleeve section 15 and also the dimensions of the cylindrical annular-sleeve section 16 of the component part 2 are adjusted in such a manner to the inside diameter of the annular-wall sections 17 and 18 of the component part 3 that during the axial mounting of the outer component part 3 onto the inner component part 2 there results a sealed circumferential fit of the component part 3 on the component part 2. Since the component part 2 has the conical annular-sleeve section 15, which extends to the front-side cover area, a circular annular space remains in the assembled state between the outer component part 3 and the inner component part 2 in the area of the annular-space section 19. The annular-space section 19 itself is designed cylindrically so that an annular free space remains directly following the front-side cap area of the outer component part 3. Since the corresponding wall surfaces of the annular-wall section 17 of the outer component part 3 on the one side and the conical annular-sleeve section 15 of the inner component part 2 on the other side offer in the assembled state a circular sealed fit, the annular space is merely in the area of the swirler device 14 open toward the swirler chamber 8 (FIG. 1). From this results a corresponding flow path starting out from the not illustrated pump system, which is inserted into the mount connector 5, through the axial channel section 6 and the radial flow-channel section 7 into the annular-space section 19 and from there finally at the height of the outlet nozzle 9 into the swirler space 8 directly in front of the outlet nozzle 9. As soon as the liquid is therefore moved under pressure out of the pump system into the axial channel section 6 and the flow-channel section 7, it is pressed into the annular-space section 19. From there it can only take the path through the swirler space 8 and is thus swirled in the area of the outlet nozzle 9 and is divided in the spray mist into tiny liquid droplets.

In order to be able to axially fix the outer component part 3 on the inner component part 2, the outer component part 3 and the inner component part 2 have corresponding locking profilings 11, 12. The locking profiling arranged on the inner component part 2 is designed as a locking ring 11. The outer locking profiling provided on the outer component part 3 is designed as an annular locking groove 12.

A conical incline 13 is provided on the inside in the area of one lower front edge of the outer component part 3, which incline 13 simplifies the mounting of the outer component part 3 on the inner component part 2.

Thus in order to mount the spray head 1, the outer component part 3 is in a simple manner merely placed onto the inner component part 2. The two component parts 2, 3 are axially compressed until they lock together in the area of the locking profilings 11, 12. It is not necessary to align the outlet nozzle 9 in an aligning extension with respect to the radial flow-channel section 7. Instead, due to the annular-space section 19 there is in every case, independent from the angular position of the outlet nozzle 9 relative to the radial flow-channel section 7, a flow path open between the pump system and the outlet nozzle 9. The so assembled spray head can now be axially locked in a simple manner on a corresponding pump connector of the pump system of the spray gun.

The protective and covering top 4 can be moved axially from above onto the outer component part 3. The opening 10 is designed significantly larger than the conical area of the outlet nozzle 9 so that the spraying operation is not influenced by the opening 10.

1. A dispensing head for a dosing device comprising an outer component part which has at least one outlet nozzle, and comprising an inner component part, which has a flow-channel arrangement for supplying a medium to be dispensed to the outlet nozzle, whereby a flow-guiding system, in particular a swirler device, viewed in dispensing direction, is placed in front of the outlet nozzle, wherein the flow-guiding system is integrated into the outer component part.

2. The dispensing head according to claim 1, wherein the outer component part is designed as a plastic part, and that the flow-guiding system is constructed in one piece on the component part.

3. The dispensing head according to claim 1, wherein the outer component part is designed annularly, and the at least one outlet nozzle is integrated in one piece into the annular component part.

4. The dispensing head according to claim 1, wherein the inner component part is designed as a plastic part, and is adjusted as a fill body in such a manner to the annular outer component part wherein the two component parts can be joined forming an annular space keeping open a flow path to the flow-guiding system and the outlet nozzle, which annular space is part of the flow-channel arrangement.

5. The dispensing head according to claim 1, wherein the outer component part and the inner component part are arranged coaxially with respect to the annular space rotatably to one another.

6. The dispensing head according to claim 1, wherein, referred to a center longitudinal axis of the inner component part, axially acting locking means are provided for the axial fixing of the outer component part relative to the inner component part.

7. The dispensing head according to claim 1, wherein the outlet nozzle is aligned radially to the center longitudinal axis of the inner component part.

8. The dispensing head according to claim 5, wherein the peripheral surfaces of the component parts, which peripheral surfaces face one another, have adjacent to the annular space diameters which are adjusted to one another so that circumferentially a sealed fit in the joined state is achieved.

9. The dispensing head according to claim 1, wherein a protective or covering top provided with an outlet opening can be releasably mounted onto the outer component part, the outlet opening of which top is designed larger than the outlet nozzle.

10. The dispensing head according to claim 1, wherein the outer component part is held releasably on the inner component part.
